(19) United States
(12) Patent Application Publication
(10) Pub. No.: US 2015/0145169 A1
(43) Pub. Date: May 28, 2015

(54) Fabricating an Object With a Removable Raft by Additive Manufacturing

(71) Applicant: Full Spectrum Laser LLC, Las Vegas, NV (US)

(72) Inventors: Henry J. Liu, Las Vegas, NV (US); Andrew Boggeri, Las Vegas, NV (US); Rodney Chang, Las Vegas, NV (US)

(21) Appl. No.: 14/555,446

(22) Filed: Nov. 26, 2014

Related U.S. Application Data
(60) Provisional application No. 61/909,080, filed on Nov. 26, 2013.

(51) Int. Cl. B29C 67/00

(52) U.S. Cl. CPC B29C 67/0092; B33Y 10/00; B33Y 30/00
USPC 264/308; 425/470

(57) ABSTRACT

An additive-manufacturing removable raft. Layers of material are sequentially deposited on a build platform. Portions of the perimeters of the layers are defined as bevel portions, the bevel portion of each layer after the first overhanging the bevel portion of the preceding layer to form an edge surface of the raft at an acute angle with respect to the build platform.

### PRIORITY

This application claims priority from Provisional Application Ser. No. 61/909,080, titled “Easy Removal Raft for Additive Manufacturing” and filed 26 Nov. 2013, the entire contents of which are incorporated herein by this reference.

### FIELD OF THE INVENTION

This invention is in the technical field of additive manufacturing.

### BACKGROUND

Additive Manufacturing (AM), also known as three-dimensional (3D) printing, is a term describing a variety of manufacturing technologies whereby an object is created from a 3D model through selective accumulation of material. Most AM methods create three dimensional objects through sequential construction of thin layers (slices) that approximate boundary surfaces of the object. AM technologies include layered inkjet deposition, Fused Deposition Modelling (FDM), Stereo Lithography (SLA), Selective Laser Melting (SLM) and Selective Laser Sintering (SLS).

Layered inkjet deposition involves a layer-by-layer deposit of materials in a manner analogous to that used by an inkjet printer to deposit a single layer of ink onto a sheet of paper. Other 3D printing technologies typically involve layer-by-layer consolidation of powdered materials using a laser beam, an electron beam, or some other source of concentrated energy.

An object made with AM technologies is fabricated on a build platform (sometimes referred to as a base), for example a metallic plate. During fabrication the material to be deposited must stick tightly to the build platform. A first step in the fabrication process is to deposit material on the build platform to form a structure called a raft (pedestal). The raft, which can take any desired shape and thickness, prevents warping or premature detachment of the object from the build platform. A support structure (for example, a plurality of spacers) typically is formed on the raft and then the object is formed on the support structure. When the fabrication process is complete, the object is removed from the support structure.

After the fabrication process is complete, and typically after the object has been detached from the support structure, the raft must be removed from the build platform before another object can be made. This removal may be accomplished by a mechanical process such as filing, sawing, milling, spark discharge, or the like.

### SUMMARY

In one aspect, a method of fabricating an object with an easily-removed raft by additive manufacturing includes specifying a plurality of layers of material to be sequentially deposited on a build platform to form a raft on which the object is to be fabricated. Dimensions of a first layer to be deposited on the build platform are specified. A portion of a perimeter of the first layer is selected as a bevel portion. Dimensions of each of a plurality of layers to be sequentially deposited on the first layer are specified, the dimensions of each layer being such that a bevel portion of each layer will overhang a bevel portion of the preceding layer, thereby forming a beveled edge in the raft. Then a plurality of layers of material to be sequentially deposited on the raft to form the three-dimensional object are specified.

In some instances the raft is shaped as a rectangle. One or more of the sides of the rectangle may then be selected for forming the beveled edge. In other instances the raft is shaped as an ellipse or even a circle, and any part of the perimeter, for example one-half of the way around the raft, or even up to all of the perimeter, may be selected for forming the beveled edge. Other shapes are used in other embodiments.

Either before or after the layers of the raft have been specified, data descriptive of the object may be created or received from an external source. The data descriptive of the object may be combined with data describing the layers of the raft, and then raft and object may be manufactured by any suitable additive-material technique. Data descriptive of a support structure, for example a plurality of columns, may also be included.

After the material has been deposited to make the object, the object may be removed from any support structure by snapping off the support or by other suitable techniques known to the art. Either before or after the object is removed from the support structure, the raft may be pried off of the build platform by simple leverage applied to the beveled edge.

### BRIEF DESCRIPTION OF THE DRAWINGS

FIG. 1 is a bottom view looking up at a build platform with an embodiment of a rectangularly-shaped additive-manufacturing removable raft on the platform.

FIG. 1A is a side view taken along the line A-A of FIG. 1.

FIG. 2 is a bottom view looking up at a build platform with an embodiment of an elliptically-shaped additive-manufacturing removable raft on the platform.

FIG. 2A is a side view taken along the line A-A of FIG. 2.

FIG. 3 is a perspective view of an object on a support structure that in turn is on a raft according to one embodiment of an additive-manufacturing removable raft.

FIG. 4A is a flowchart illustrating an embodiment of a method of fabricating an object with a removable raft by additive manufacturing.

FIG. 4B is a flowchart illustrating another embodiment of a method of fabricating an object with a removable raft by additive manufacturing.

FIG. 5 is a flow chart illustrating another embodiment of a method of fabricating an object with a removed raft by additive manufacturing.

FIG. 6 is a side view of a removable raft being pried off of a build platform, showing forces involved in the removal.

FIG. 6A is a side view of a raft according to the prior art being pried off of a build platform, showing forces involved and resulting likelihood of damage.

FIG. 7 is a side view of a 3D printer with an object being printed including a support structure and a removable raft with beveled edge.

FIG. 8 is a close up view of a portion of FIG. 7.

FIG. 9 is a cross-sectional side view of a printed object which would probably fail due to absence of a supporting structure.

FIG. 9A shows how certain object geometries require a significant support structure and a corresponding increase in raft area and total adhesion force to the build platform.

FIG. 10 is a perspective view of a 3D printer in which embodiments of a removable raft may be fabricated by additive manufacturing.

FIG. 11 depicts a fabricated object being detached from a support structure.

### DETAILED DESCRIPTION

As discussed above, when the process of fabricating an object is complete, the raft must be removed from the build platform before another object can be made. Mechanical processes such as filing, sawing, milling, or spark discharge have been used, but these are time-consuming and awkward. Some processes involve prying the raft off of the build platform, but this has been difficult to do without damaging the build platform, and sometimes the raft has stuck to the build platform so tightly that prying has not worked. There has been a need for a way to quickly and reliably remove the raft from the build platform without time-consuming use of power tools and without damaging the build platform.

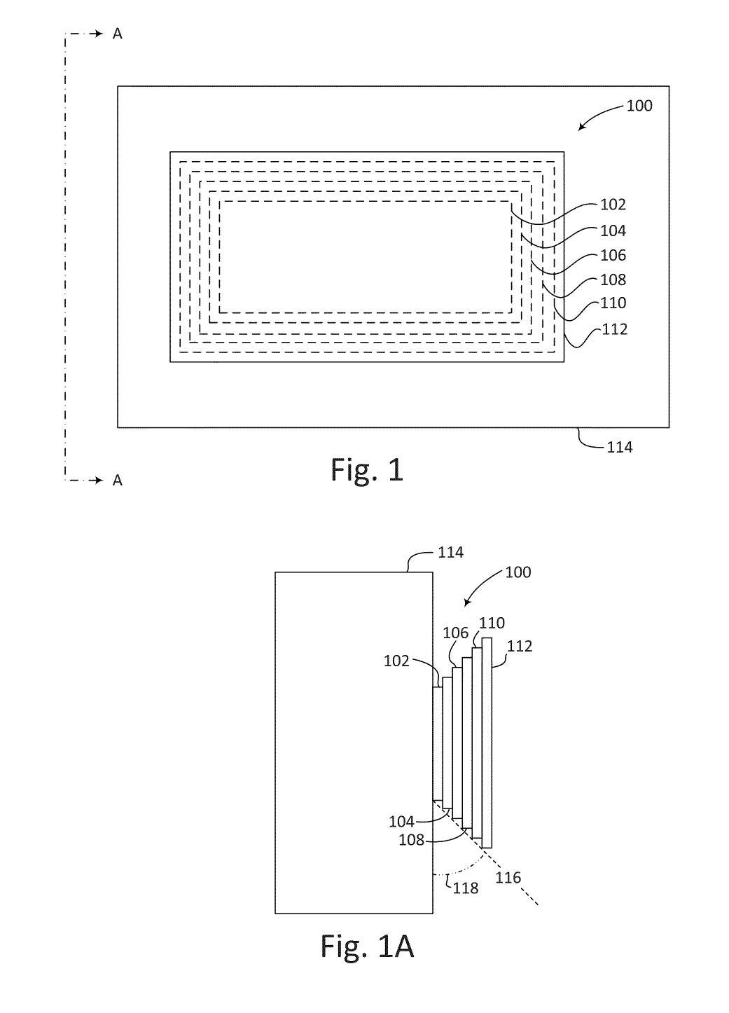

FIGS. 1 and 1A show one embodiment of an additive-manufacturing removable raft generally 100. The raft is formed of a plurality of layers 102, 104, 106, 108, 110, and 112 of material sequentially deposited on a build platform 114. A portion of the perimeter of each layer is defined as a bevel portion. In this embodiment, the entire perimeter of each layer is defined as the bevel portion. The bevel portion of each layer after the first layer 102 overhangs the bevel portion of the preceding layer to form an edge surface 116 of the raft at an acute angle 118 with respect to the build platform 114. Although six layers are shown, in practice the raft may comprise many more layers, each very thin.

In the embodiment shown in FIGS. 1 and 1A, the layers are rectangular in shape and the bevel portion of each layer comprises all four edges of each rectangle. In other embodiments, only one or some of the edges, rather than all four, may comprise the bevel portion. In some embodiments the layers may be square. In other embodiments the layers may be shaped as any regular or irregular polygon such as a triangle, a pentagon, a hexagon, etc., or most any regular or irregular shape as may be convenient to accommodate the object being fabricated or to fit on the build platform. The edges need not define straight lines; rather, any portion of the perimeter of the layers may be curved.

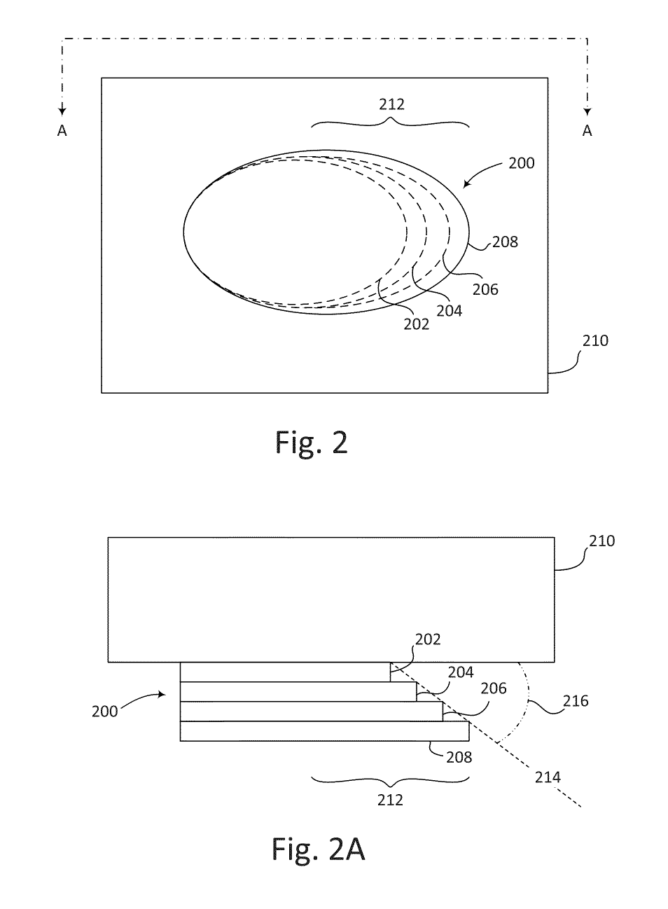

FIGS. 2 and 2A show an embodiment of an additive-manufacturing removable raft generally 200. The raft is formed of a plurality of layers 202, 204, 206, and 208 of material sequentially deposited on a build platform 210. In this embodiment about half of the perimeter of each layer is defined as a bevel portion 212 but in other embodiments more or less than half of the perimeters of the layers may be defined as the bevel portions. The bevel portion of each layer after the first layer 202 overhangs the bevel portion of the preceding layer to form an edge surface 214 of the raft at an acute angle 216 with respect to the build platform 210. Although four layers are shown, in practice the raft may comprise many more layers, each very thin. In this embodiment the layers are shown as elliptical in shape. In other embodiments the ellipse may be circular, and in still other embodiments the layers may be of other shapes as desired to best accommodate the object being fabricated or the build platform or both.

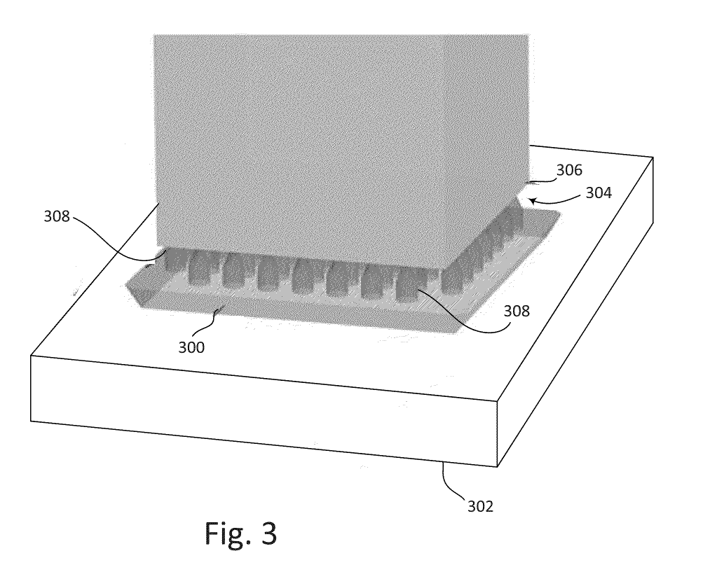

The embodiment shown in FIGS. 1 and 1A is formed on the bottom of the build platform with the raft hanging down, as would be fabricated in an additive-manufacturing machine that prints from the top down. This orientation is not critical, and any other orientation, for example a build from bottom-up as shown in FIG. 3, would work just as well. In FIG. 3, a beveled raft 300 is shown on top of a build platform 302 with a support structure 304 on the raft 300 and an object 306 on the support structure 304. In this embodiment the support structure 304 comprises a plurality of columns including the column 308. In other embodiments the support structure may take a different form.

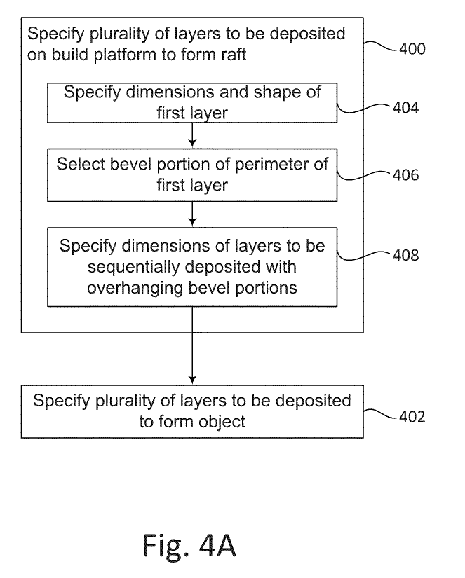

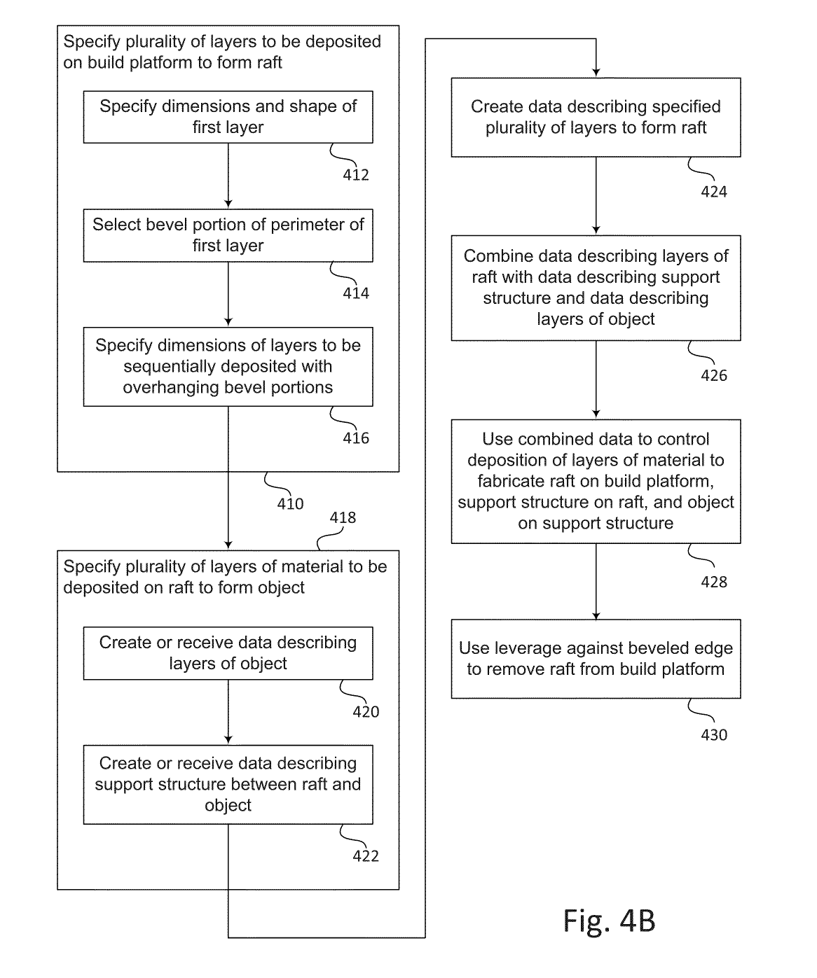

FIG. 4A illustrates an embodiment of a method of fabricating an object with a removable raft by additive manufacturing. The method comprises specifying a plurality of layers of material to be sequentially deposited on a build platform to form a raft on which the object is to be fabricated (400) and specifying a plurality of layers of material to be sequentially deposited on the raft to form the object (402). Specifying the layers to form the raft (400) includes: specifying dimensions and shape of a first layer to be deposited on the build platform (404), selecting a portion of a perimeter of the first layer as a bevel portion (406), and specifying dimensions of each of a plurality of layers to be sequentially deposited on the first layer, the dimensions of each layer being such that a bevel portion of each layer overhangs a bevel portion of the preceding layer (408).

As in the embodiments of the raft previously discussed, orientation with respect to vertical and horizontal axes is not critical and any convenient orientation may be used. The layers may be rectangular in shape, or elliptical, or some other shape as desired. Each layer may be very thin, and many layers may be used to build the removable raft.

FIG. 4B illustrates another embodiment of a method of fabricating an object with a removable raft by additive manufacturing. The method begins with specifying a plurality of layers of material to be sequentially deposited on a build platform to form a raft on which the object is to be fabricated (410) This includes: specifying dimensions and shape of a first layer to be deposited on the build platform (412), selecting a portion of a perimeter of the first layer as a bevel portion (414), and specifying dimensions of each of a plurality of layers to be sequentially deposited on the first layer, the dimensions of each layer being such that a bevel portion of each layer overhangs a bevel portion of the preceding layer (416). A plurality of layers of material to be sequentially deposited on the raft to form the object are specified (418). This includes creating data describing layers of the object, or receiving from an external source data describing layers of the object, or both (420). In some embodiments it also includes creating, or receiving from an external source, data describing layers of a support structure to be fabricated between the raft and the object (422), for example the columns 308 as shown in FIG. 3.

Data are created describing the specified plurality of layers to form the removable raft (424). The data describing the layers of the raft are combined with the data describing the object to be fabricated and, in some embodiments, the data describing the support structure (426). The combined data are used to control deposition of layers of material to fabricate the removable raft on the build platform and the object on the raft (428). If a support structure is used, the support structure is fabricated on the raft and then the object is fabricated on the support structure. Leverage is used against the beveled edge to pry or otherwise remove the raft from the build platform (430).

The layers may be deposited by any of the devices and techniques mentioned above or by any other suitable device or technique as desired. Any material suitable for additive manufacturing may be used.

After the fabrication is complete, mechanical leverage is used against the beveled edge of the raft to pry the raft off of the build platform. The object, and the support structure if used, may be removed from the raft either before or after the raft is removed from the build platform. The beveled edge on the raft makes it possible to quickly and easily pry the raft off without power tools and time-consuming manipulation and without damaging the build platform.

The support structure, if used, may take the form of a plurality of columns 308 as shown in FIG. 3. These columns may be tapered at one or both ends, down to providing only infinitesimal contact with the object, to facilitate removal of the object from the support structure and of the support structure from the raft. In such a case the object 306 can be removed from the support structure by very small force, for example by hand. The build platform may be solid metal or metal-surfaced, and the removable raft may stick so strongly to the build platform that a tool must be used to remove it. The beveled edge enables use of a simple tool to quickly and easily remove the raft without damaging the surface of the build platform.

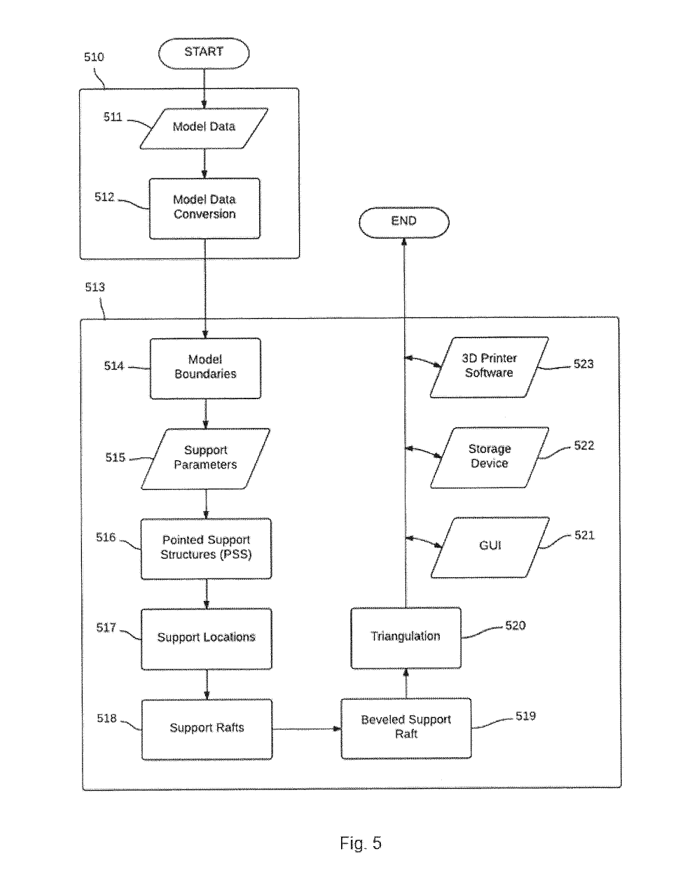

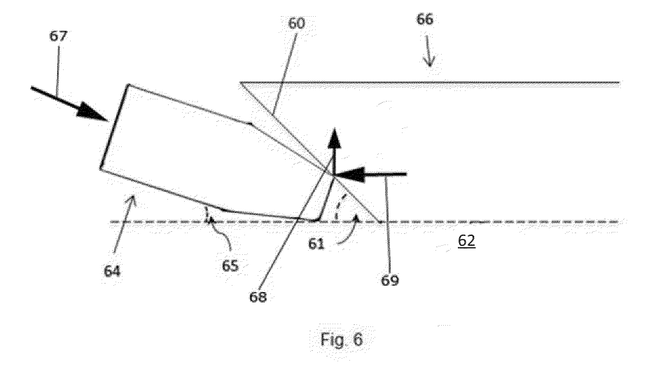

Referring now to FIG. 5, there is shown an embodiment of a method for generating beveled raft support structures. The model data importer 510 reads model data 511 and processes it using a converter 512 to give data compatible with the beveled raft support generator 513. If the model data is already compatible, then the model data importer 510 may be omitted. The beveled raft support generator 513 analyzes the data from the model data importer 510 and determines the model boundaries 514. Support parameters 515 are read and support structures 516 are generated. Support locations 517 are extracted from the support structures 516. Using support locations 517, support rafts 518 are created and stored in an intermediate format. Beveled support rafts 519 are created using support rafts 518 and also stored in an intermediate format. The results are then sent through a triangulation algorithm 520 to produce a model representation in triangulated mesh form. The meshes can be drawn in a graphical user interface 521, written to a storage device 522, and/or sent to 3D printer software 523, which can then print the beveled raft support. Note that triangulation may be omitted if meshes are not necessary and a model slicer may be included in the beveled raft support generator 513 if slices of the model are needed. Also, the beveled raft support generator 513 may be designed to process slice data instead of model data. In this case, the beveled support rafts 519 are created after support rafts 518 are generated and sliced. It

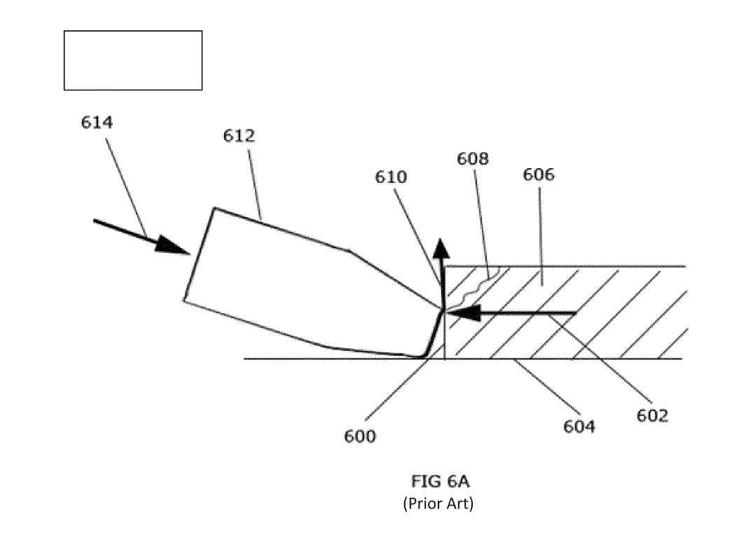

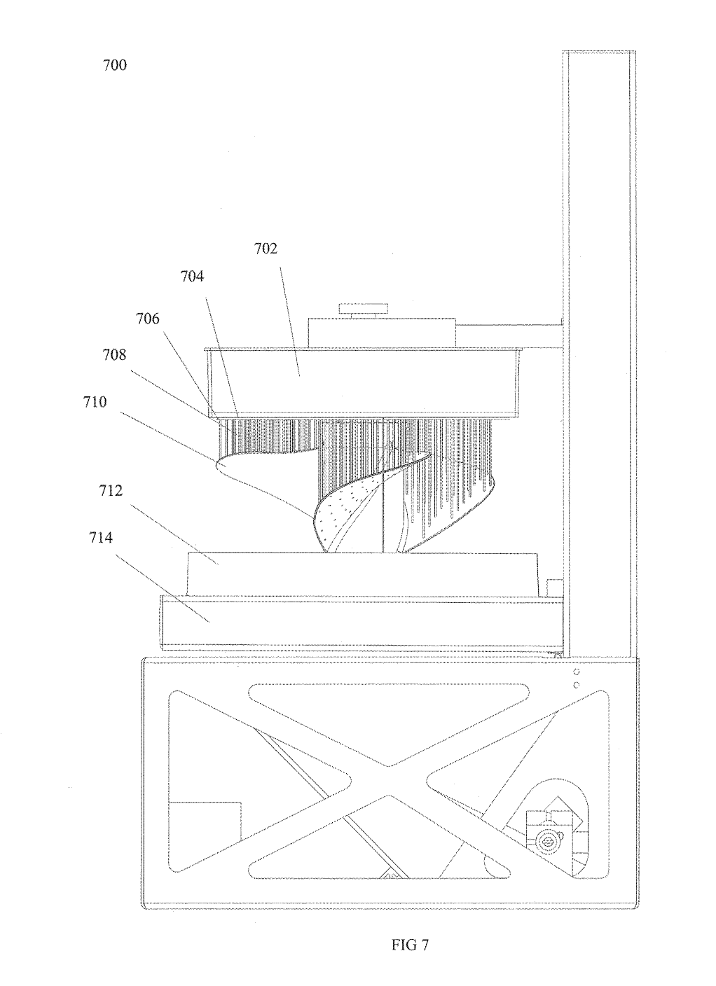

Referring now to FIG. 6, there is shown a profile view of an embodiment of a bevel 60 on a beveled raft 66 with a bevel angle 61. The raft is formed on a build platform 62. There is also shown a removal tool 64 acting along an angle 65 and an adhesive force 69 acting parallel the build platform 62. The adhesive force counteracts the applied force due to the removal tool 64. The beveled edge 60 of the removable raft serves to restrict the movement of the removal tool 64 and concentrate the applied force 67 against the adhesive force 69. The bevel 60 allows for application of shear, leverage, or both forces in order to remove the raft 66 from the build platform 62.

In some embodiments the acute angle 118 in FIG. 1A and 216 in FIG. 2A may be between 45 degrees and 60 degrees.

FIG. 6A shows that application of tool force to a non-beveled raft often results in tool slippage and resulting damage to valuable parts such as the surface of the build platform. A raft 606 with a non-beveled sidewall 600 is shown on a build platform 604. A tool 612 is applied in an attempt to remove the raft 606 from the platform 604. Adhesive force 602 between the raft 606 and the platform 604 resists the action of the force 614 exerted on the tool 612. A fracture crack 608 may develop in the raft 606 due to the tool impact force 614. Tool impact force can be decomposed into a vertical component 610 and the horizontal component 602. These components act inside the raft 606 and lead to flaking or cracking of the corners when impacted by a normal tool.

Embodiments of the removable raft as described herein overcome the difficulties of the prior art by directing the tool impact force into the interface between the raft and the build platform as described above with reference to FIG. 6, where the force 67 exerted through the tool 64 raises the raft 66 from the build platform 62 and the tool slides between them.

FIG. 7 shows a profile view of a printed object in a printer. 702 is the build platform. 704 is the raft with beveled edge 706. 708 represents many long thin vertical strands comprised in a support structure that connects the raft 704 to the printed object 710. 712 is a vat which contains a liquid resin and 714 is a vat holder.

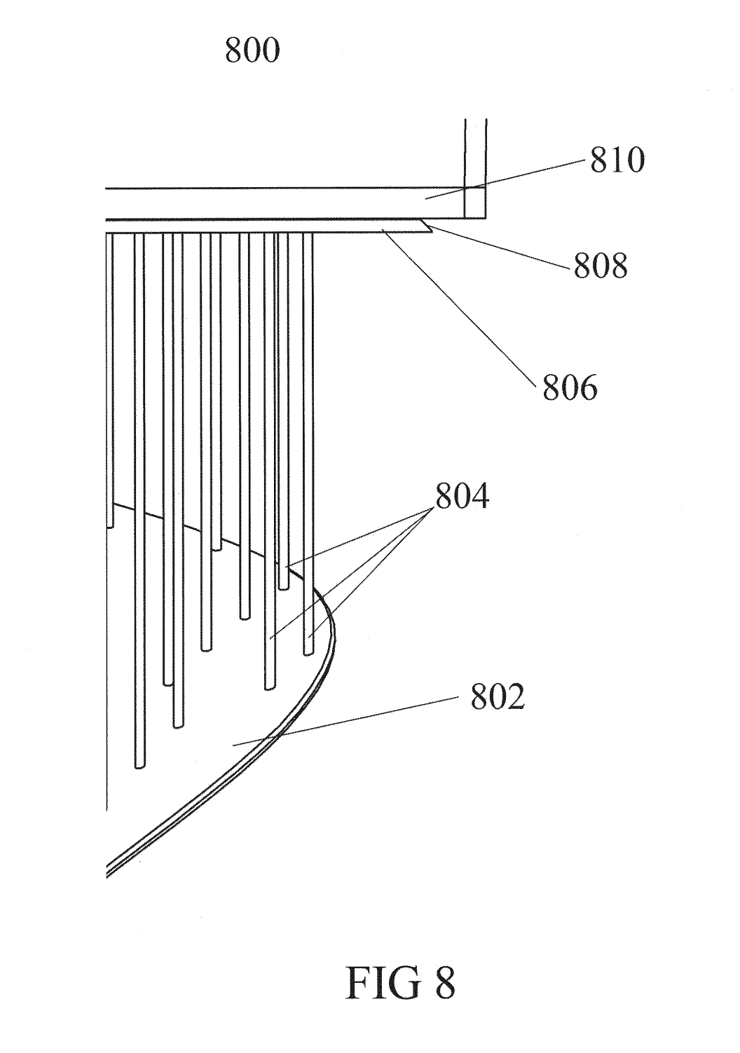

FIG. 8 shows a beveled raft 806 with a beveled edge 808 on a build platform 810. A support structure including a plurality of columns 804 connects the raft 806 with the object 802 that is being fabricated.

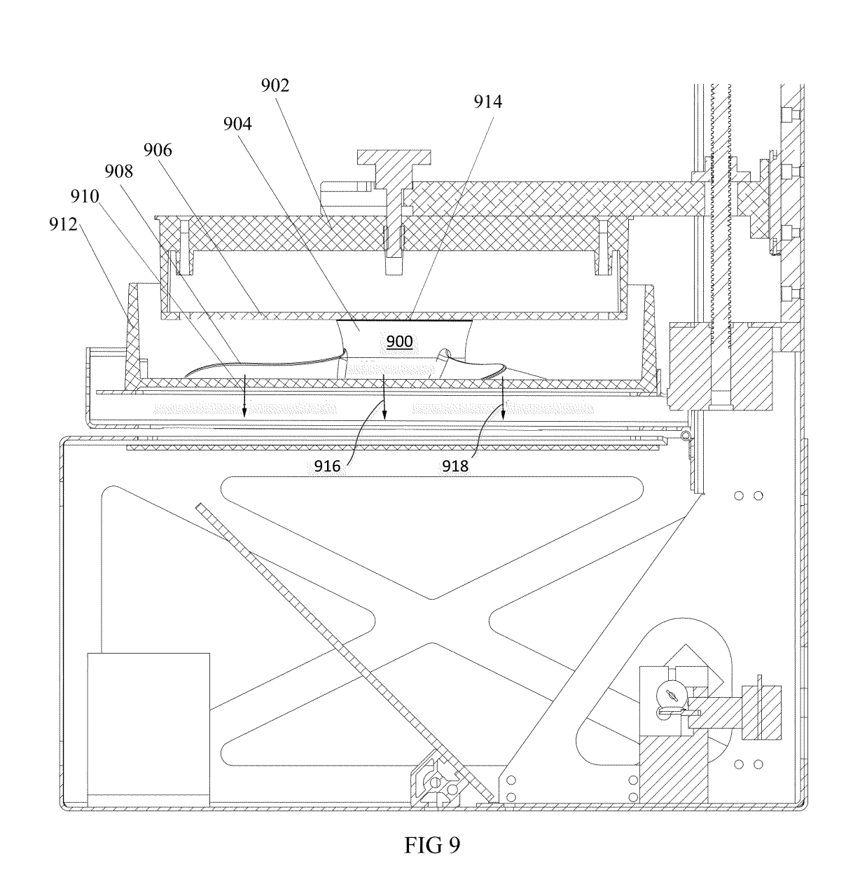

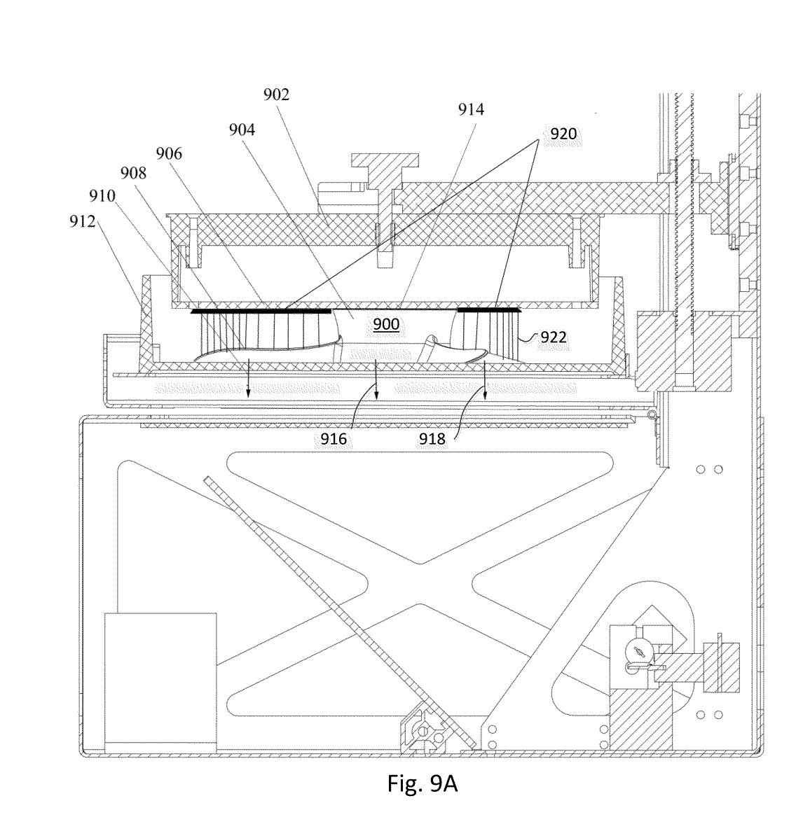

FIG. 9 depicts an object 900 that is likely to fail during printing due to lack of supports. Three arrows 910, 916, and 918 in the middle of the figure represent forces on the object 900 when the object is being lifted up from a build vat 912 by a build platform 902. Some of this force is from suction that has to be overcome from viscous liquid resin and some of this force is from bonding of the printed object 900 to the vat release layer (the bottom of the vat 912). The force represented by the middle arrow 916 is exerted on the central section 904 of the object 900 and is distributed across interface 914 where the object 900 and build plate 902 connect with significant contact area. However, the object is likely to break because of the force represented by the outer arrows 910 and 918 acting on a cantilever geometry 908 of the object 900. The area 906 of the build platform 902 does not have any raft or support members between the cantilevered part section 908 and the build platform 902. Without this support, the cantilevered part section 908 is susceptible to failure by cracking, with the highest likelihood near the juncture with the central section 904.

FIG. 9A shows the same printed object as in FIG. 9 but with a much larger contact area between the object 900 and build platform 902 occupying the area 906 that was empty in FIG. 9. Much of this contact area is from an additional raft 920 and support structure 922 with the additional raft 920 shown with exaggerated thickness to differentiate from the original raft 914. In practice the entire raft, including the parts designated as 914 and 920 in the figure, may be fabricated as a single unit. So now instead of bending and breaking the cantilevered part section 908, the forces represented by the outer arrows 910 and 918 are passed through the corresponding support structure 922 to the build platform 902.

A bevel-edged raft is of even greater utility when removing objects that have large areas of contact with the build platform, such as the object 900 in FIG. 9A, because the total adhesion force between the object and the build plate is correspondingly larger.

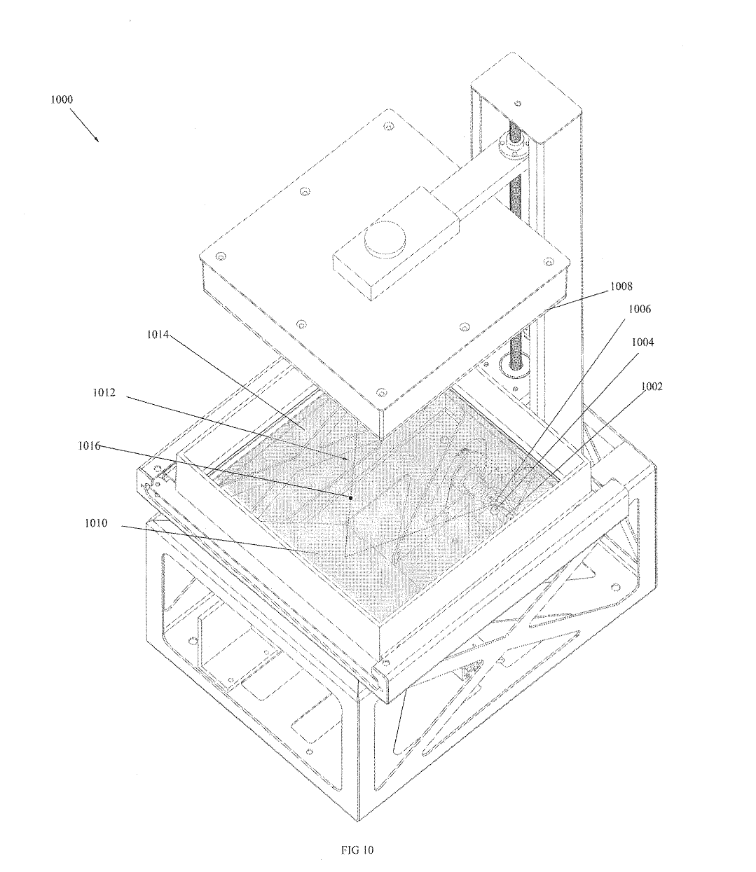

FIG. 10 is a perspective view of the additive manufacturing apparatus shown in FIGS. 9 and 9A. There is shown a perspective view of a laser-based AM device 1000 having a laser diode assembly 1002, actuated X galvanometer mirror 1004, actuated Y galvanometer mirror 1006, fixed main mirror 1010, and a build plane area 1014. In operation, a laser beam 1012 is generated by the laser diode assembly 1002.

In more detail, still referring to the preferred embodiment in FIG. 10, the laser beam 1012 is directed in space by commanding the rotational position of the galvanometer mirrors 1004 and 1006. The main mirror 1010 reflects the beam 1012 upwards to reach a target point on the build plane 1014.

In further detail, still referring to FIG. 10, the laser-based AM device 1000 is operated by steering the laser 1012 to a target point 1016. In the preferred embodiment, a layer is composed of vectors defining contours and fills, with the vectors created from a plurality of calibrated target points and interpolated paths. Steering of the laser 1012 is accomplished by applying a control signal to the galvanometer mirrors 1004 and 1006. Given a target point 1016 on the build plane 1014, the galvanometer mirrors 1004 and 1006 will be adjusted according to our calibration so that the laser 1012 strikes the target point 1016.

The construction details of FIG. 10 are that the laser-based AM device 1000 may use servo-actuated (galvanometer) mirrors 1004 and 1006 or other types of steering devices to steer the laser beam 1012. The laser-based AM device 1000 may or may not include one or more fixed mirrors 1010 to direct the laser 1012 to intersect the build plane 1014. The laser beam 1012 may be emitted by the laser diode 1002 or other radiation source which may be located below the build plane 1014 as in the figure or in other embodiments above or beside the build plane 1014.

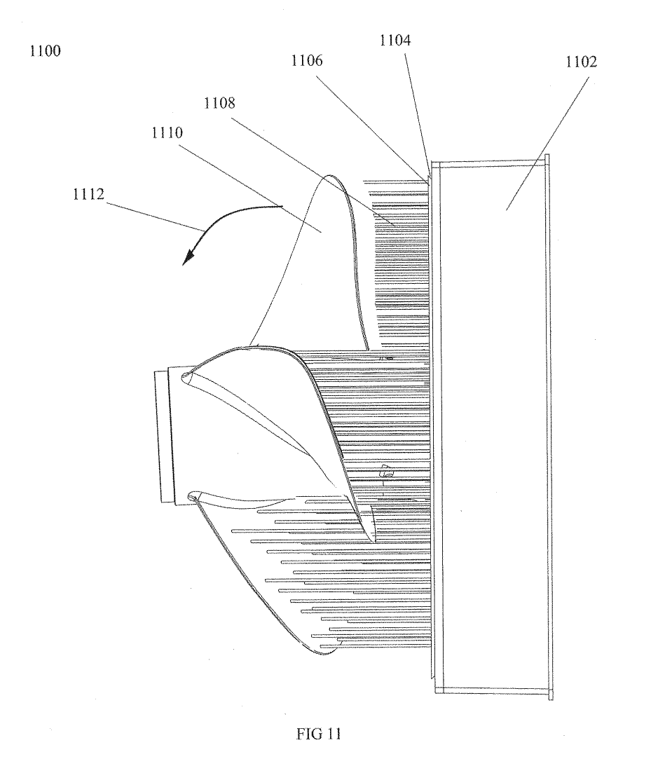

FIG. 11 is an additional depiction of the forces involved in separating an object with cantilevered areas from supports and raft. A build platform 1102 is shown with a raft 1106 having a beveled edge 1104. A support structure 1108 supports an object 1110 on the raft 1106. A typical removal force to separate the raft 1106 from the build platform 1102 is represented by an arrow 1112.

It is with printed objects with large contact areas that the beveled edge is especially useful in reducing the force of separation and making removal easier. Large contact areas correlate to higher force levels to overcome the adhesion between object and build platform. The beveled edge on the raft reduces the possibility of a removal tool being deflected and damaging the printed object or the build platform. The angle of the beveled edge also improves the ease of separating the raft from the build plate.

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above described embodiment, method, and examples, but by all embodiments and methods within the scope of the claims.

We claim:

1. An additive-manufacturing removable raft comprising a plurality of layers of material sequentially deposited on a build platform, a portion of the perimeters of the layers being defined as bevel portions, the bevel portion of each layer after the first overhanging the bevel portion of the preceding layer to form an edge surface of the raft at an acute angle with respect to the build platform.

2. The raft of claim 1 wherein the layers are polygon shaped.

3. The raft of claim 1 wherein the layers are elliptical in shape.

4. The raft of claim 1 wherein the layers are rectangular in shape and the bevel portion of each layer comprises at least one side of the rectangle.

5. The raft of claim 1 wherein the layers are irregularly shaped.

6. A method of fabricating an object with a removable raft by additive manufacturing, the method comprising:
specifying a plurality of layers of material to be sequentially deposited on a build platform to form a raft on which the object is to be fabricated, including:
specifying dimensions and shape of a first layer to be deposited on the build platform,
selecting a portion of a perimeter of the first layer as a bevel portion, and
specifying dimensions of each of a plurality of layers to be sequentially deposited on the first layer, the dimensions of each layer being such that a bevel portion of each layer overhangs a bevel portion of the preceding layer; and
specifying a plurality of layers of material to be sequentially deposited on the raft to form the object.

7. The method of claim 6 wherein the specified shape comprises a polygon.

8. The method of claim 7 wherein selecting a portion of the perimeter of the first layer comprises selecting at least one side of the polygon as the bevel portion.

9. The method of claim 6 wherein the specified shape comprises an ellipse.

10. The method of claim 9 wherein the ellipse is circular.

11. The method of claim 9 wherein selecting a portion of the perimeter of the first layer comprises selecting at least one-half of the perimeter as the bevel portion.

12. The method of claim 6 wherein specifying the plurality of layers to form the object comprises at least one of creating data describing the layers and receiving data describing the layers.

13. The method of claim 12 wherein specifying the plurality of layers to form the object comprises at least one of creating data describing a support structure and receiving data describing a support structure, the support structure to be formed between the raft and the object.

14. The method of claim 13 wherein the support structure comprises a plurality of columns.

15. The method of claim 12 and further comprising:
creating data describing the specified layers of the raft;
combining that data with the data describing the layers of the object; and
using the combined data to control deposition of successive layers of material and thereby fabricate the raft on the build platform and the object on the raft.

16. The method of claim 15 and further comprising using leverage against the beveled edge of the raft to remove the raft from the build platform.

17. The method of claim 13 and further comprising:
creating data describing the specified layers of the raft;
combining that data with the data describing the support structure and the data describing the layers of the object; and
using the combined data to control deposition of successive layers of material and thereby fabricate the raft on the build platform, the support structure on the raft, and the object on the support layer.

18. The method of claim 17 wherein the support structure comprises a plurality of columns.

19. The method of claim 17 and further comprising using leverage against the beveled edge of the raft to remove the raft from the build platform.
